(19) United States
(12) Patent Application Publication
(10) Pub. No.: US 2010/0133081 A1
(43) Pub. Date: Jun. 3, 2010

(54) Keypad manufacturing method and device thereof

(76) Inventors: Chien-Kuo Tang, Xin Dian City (TW); Li-Jen Kao, Shu Lin City (TW); Hsu-Chang Liu, Taipei City (TW); Tsung-Shan Hou, Tu Chen City (TW); Ming-Jr Ye, Taipei County (TW)

Correspondence Address: SINORICA, LLC, 2275 Research Blvd., Suite 500, ROCKVILLE, MD, 20850, US

(21) Appl. No.: 12/325,297

(22) Filed: Dec. 1, 2008

(51) Int. Cl. H01H 9/00; B29C 35/08

(52) U.S. Cl. 200/5 A; 264/496

(57) ABSTRACT

A keypad manufacturing method and a device thereof are disclosed. The keypad manufacturing method includes the steps of: (1) pouring materials for a keypad into a mold; (2) covering a film on the mold; (3) film printing: arranging a printed layer on the film; (4) attaching a layer of positioning plate; that's to attach the film with the printed layer on the layer of positioning plate. The device consists of a film which is a transparent layer; a keypad set formed by a plurality of keypads arranged on the film and a connecting piece is located on bottoms of two adjacent keypads; a printed layer disposed on bottom of the film to form characters or symbols corresponding to the keypads. Therefore, the manufacturing of the keypad device is easy, convenient for mass-production, with lower cost of related equipment, reduced operation time and higher yield rate. Moreover, both economic benefits and competitiveness of products are improved.

### BACKGROUND OF THE INVENTION

The present invention relates to a keypad technology, especially to a keypad with high yield rate, high quality, easy manufacturing, and convenience of mass production. Moreover, the keypad manufacturing method and the device thereof can improve economic benefits of manufacturing as well as product competitiveness.

Conventional manufacturing processes of keypad of cellar phones, home phones, calculators and personal digital assistants (PDA) are as shown from FIG. 1 to FIG. 2D. A keypad plate 80 is formed by plastic injection. The keypad plate 80 includes a plurality of keys 81 that connects with a frame 83 by means of an bone-like member 82. Then a sprayed laser-marked layer 84 is arranged on top surface of the keypad 81 and a printed layer 85 is disposed on bottom surface of the keypad 81. The sprayed laser-marked layer 84 is used to form characters and symbols on the keypad 81. Next by die-cutting, the bone-like member 82 and the frame are removed so as to form a plurality of separated keys 81. The keys 81 with the sprayed laser-marked layer 84 on top surface thereof respectively are attached on a rubber plate 86 so as to form a complete keypad device. However, the equipment required and manufacturing cost of the keypad plate 80 are quite high due to plastic injection processes. Moreover, the keys 81 are manually arranged on a key tray and then attached on the rubber plate 86. The manufacturing processes become trivial, complicated, and time-consuming. This is not only with poor economic benefits, but also having shortcomings of wrong positions or failings of the keypads 81. Thus the steps of the conventional technology: injection molding→spraying→laser-marking→uv coating→back-printing color layers→die-cutting→arranging the keys on the key tray→attaching the keypads on the rubber plate→final product; are not good manufacturing processes.

Refer from FIG. 3A to FIG. 3E, manufacturing processes of another prior art are revealed. A film 90 is used as substrate and a printed layer 91 is arranged on rear side of the film 90. Then the film 90 is set into a mold 96 (such as vacuum molds) to perform a stretch forming process, as shown in FIG. 3B. Next the stretched film 90 is put into an injection mold 92 to perform injection molding of the plastic 93 being filled therein.

Then by die-cutting, a plurality of separated keys 94 is formed and finally is attached on a rubber plate 95. This way also has drawbacks of high cost of manufacturing devices and processes, low economic benefits and easy falling or wrong positions of the keys. While being injecting and molding, three surfaces of the keys 94 are covered by the film 90 and connection between the keys 94 is formed. This leads to reduced yield rate. Thus another conventional way by steps of: film printing→stretch forming→cutting→in-mold injection→die-cutting to form keys→arranging the keys on the key tray→attaching the keys on a rubber plate→final product of the keypad is also not an ideal manufacturing way.

Refer to Taiwanese patent No. 366463, the shortcoming of this prior art is in that: while treating the resin in the second mold with UV irradiation, part of UV light is prevented by a light shielding layer over the PET film so that the resin is not cured evenly. Some of the resin under the light shielding layer is cured slower while unshielded part is cured quicker. Thus the curing quality of the resin is poor and the lifetime of the keypad is also affected. Moreover, conventional technique puts the semi-product into a second mold so that the resin inside the second mold is difficult to be treated for removing bubbles inside the resin. This also has negative effects on the quality of the molded resin. Furthermore, the production of the keypad requires more steps. The more the manufacturing processes are, the lower the yield rate is. The defects found are getting more. The yield rate has great effects on the economic effect. As to Taiwanese Pub. App. No. 200802453, the shortcoming of this prior art is in that the lower part (rubber elastic layer) of the keypad is made by injection or hot press so that the manufacturing time increases. This is negative for fast and mass production that bring economic effects and there is a need to improve such manufacturing processes. Thus there is a need to provide a new manufacturing method of keyboards that improves shortcomings of prior arts such as low production efficiency, high manufacturing equipment, lower yield rate and low economic benefits.

### SUMMARY OF THE INVENTION

Therefore it is a primary object of the present invention to provide a manufacturing method of keyboards and devices thereof that simplifies manufacturing of keyboards and makes mass-production of the devices more easily and conveniently so as to reduce cost of manufacturing equipment, shorten operation time and increase throughput. Moreover, both economic benefits and competitiveness of products are improved. In order to achieve above objects, the method includes the following steps:

(1) pouring materials for a keypad into a mold;

(2) covering a film on the mold;

(3) film printing: arranging a printed layer on the film;

(4) attaching a layer of positioning plate; that's to attach the film with the printed layer on the layer of positioning plate.

Another embodiment of the method according to the present invention includes the following steps:

(1) pouring materials for keypad sets into a first mold;

(2) covering a first film on the first mold;

(3) curing: applying UV light to cure keypad sets and connect the keypad sets firmly with the first film;

(4) printing the first film to get a semi-product of the keypad set;

(5) assembling the semi-product of the keypad set with a semi-product of an elastic member set which is formed by pouring materials for the elastic member set into a second mold and then covering a second film on the second mold to be irradiated by UV light for curing the elastic member set and connecting the elastic member set tightly with the second film.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing of a prior art;

FIG. 2A to FIG. 2D are schematic drawings showing flow chart of the manufacturing processes of a prior art;

FIG. 3A to FIG. 3E are schematic drawings showing flow chart of the manufacturing processes of another prior art;

FIG. 4 is a schematic drawing showing a keypad of the present invention;

FIG. 5 is a flow chart showing manufacturing processes of a keypad according to the present invention;

FIG. 6A to FIG. 6F are schematic drawings showing flow chart of the manufacturing processes of a keypad according to the present invention.

FIG. 7 is a schematic drawing showing structure of another embodiment of a keypad according to the present invention;

FIG. 8 is a flow chart showing manufacturing processes of another embodiment of a keypad set according to the present invention;

FIG. 9A to FIG. 9D are schematic drawings showing steps of the manufacturing processes of the keypad set according to the present invention;

FIG. 10 is a flow chart showing manufacturing processes of an embodiment of an elastic member set according to the present invention;

FIG. 11A to FIG. 11C are schematic drawings showing steps of the manufacturing processes of the elastic member set according to the present invention;

FIG. 12 is a schematic drawing showing gluing of the keypad set with the elastic member set.

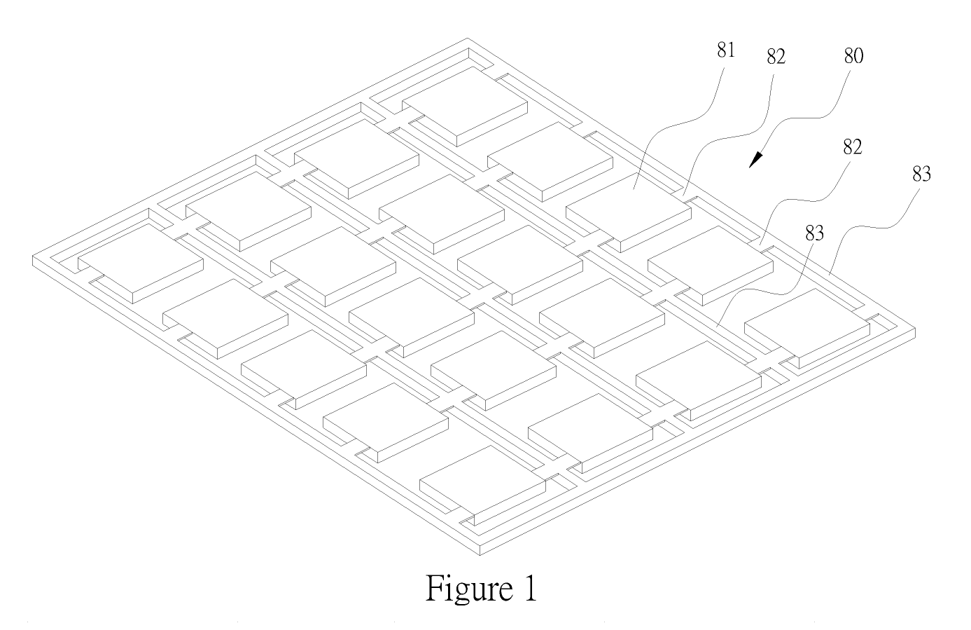

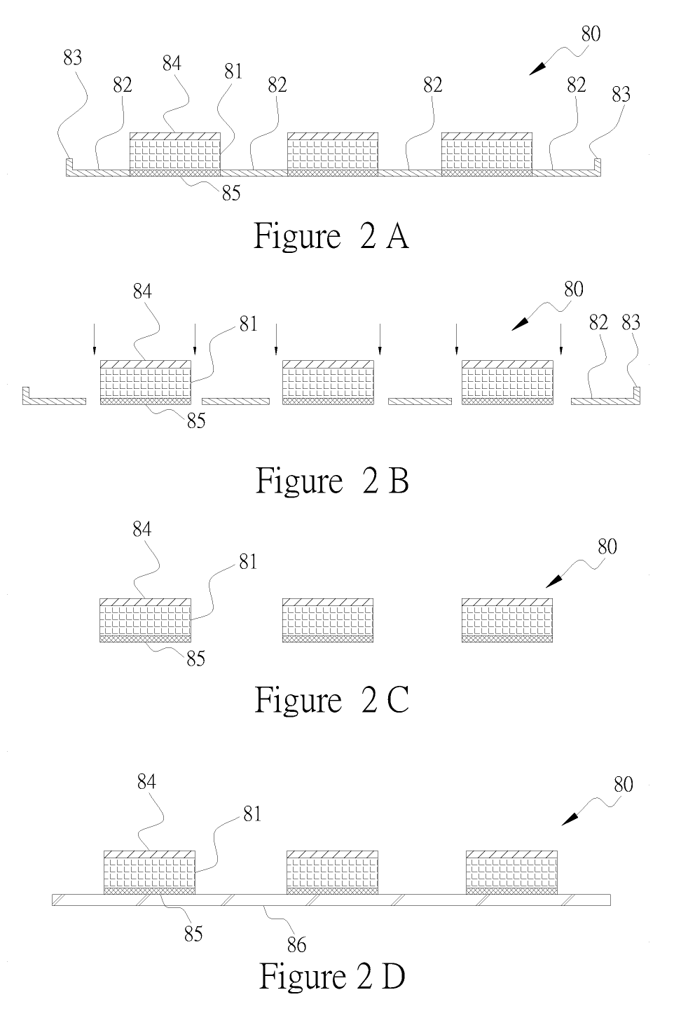

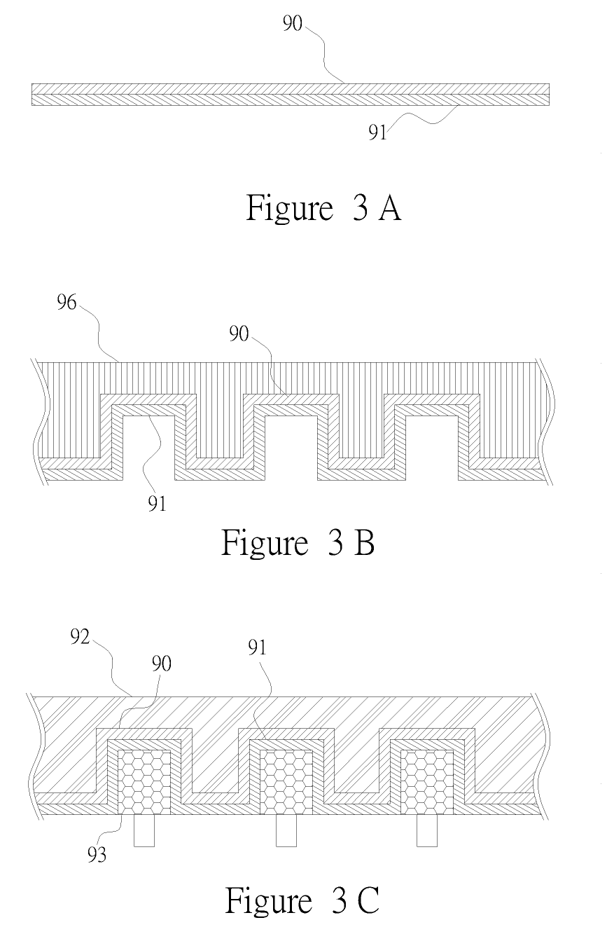

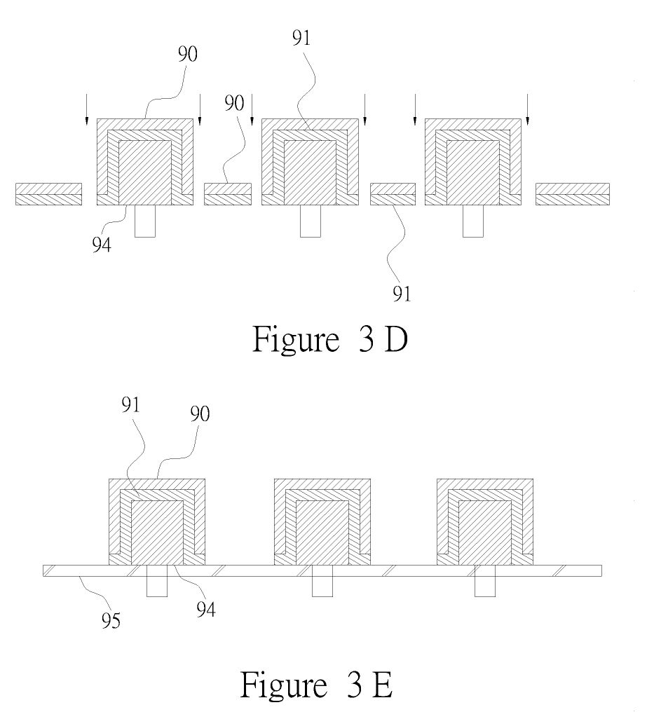

### DETAILED DESCRIPTION OF THE PREFERRED EMBODIMENT

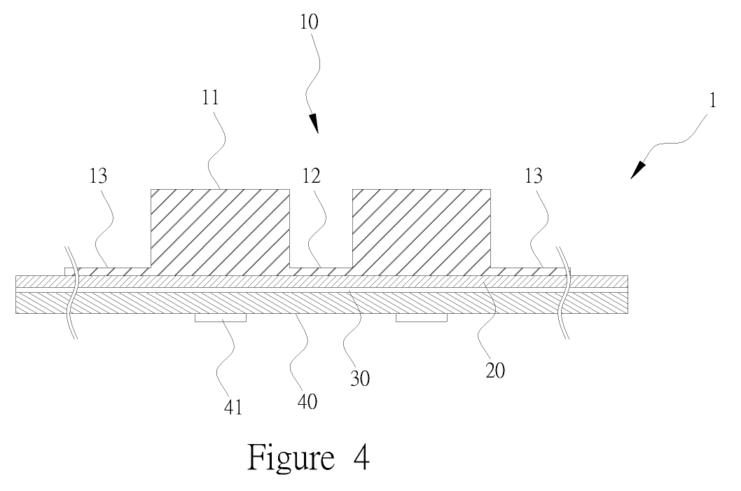

Refer to FIG. 4, a first embodiment of a keypad device 1 according to the present invention consists of a keypad set 10, a film 20, a printed layer 30 and a layer of positioning plate 40. The keypad set 10 includes a plurality of keypads 11. The plurality of keypads 11 is an integrated part formed by transparent resin. A connecting piece 12 is located between the bottom of the two adjacent keypads 11. A side piece 13 is extended from bottom of the keypad 11 on the edges. The film 20 is a transparent layer (or a see-through layer) for accommodating and connecting the keypad set 10. That means the plurality of keypads 11 are cured and disposed on the top surface of the film 20. The printed layer 30 is disposed on bottom side of the film 20 and is able to be disposed on the film by a printing way so as to form characters and symbols corresponding to the keypads 11. The layer of positioning plate 40 is arranged under the film 20 and the printed layer 30. The layer of positioning plate 40 is made from rubber or Electro Luminescent/light guiding material such as Rubber,EL,LGP,LGF,LGR etc. Under the layer of positioning plate 40, a stopper press member 41 is arranged projectingly, corresponding to the keypad 11.

The connecting piece 12 and the side piece 13 of the keypad set 10 enable the connection between the keypads 11 tight, without gap or opening so that the keypad device 1 has high shielding efficiency, good backlight, and light tight. Moreover, the printed layer 30 is arranged on the keypad 11 by back-printing so that the user's finger won't contact the ink while pressing the keypad 11. Thus the keypad device 1 is durable and the characters as well as symbols thereon are sill clear after long-term use. There are two kinds of material of the keypad set 10-soft material or hard material. The hardness of the soft material is about pencil hardness HB (features on excellent scratch resistance) while the hardness of the hard material is about pencil hardness 2H.

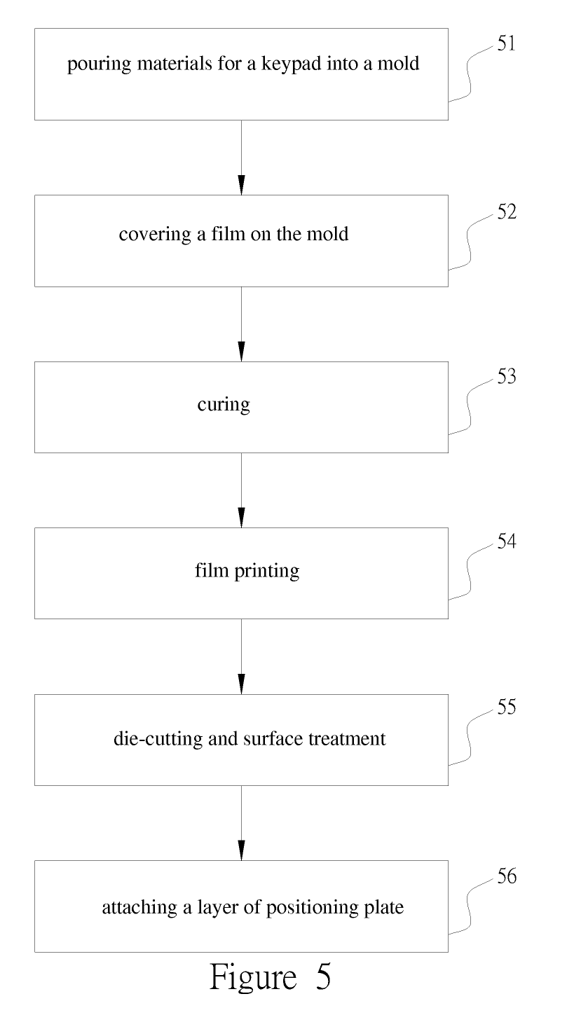

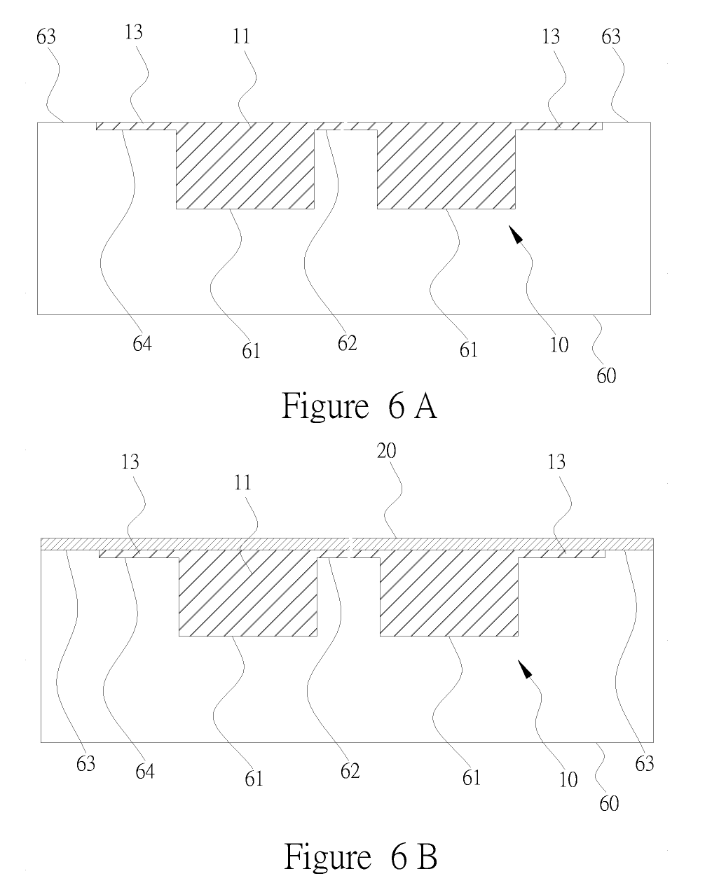

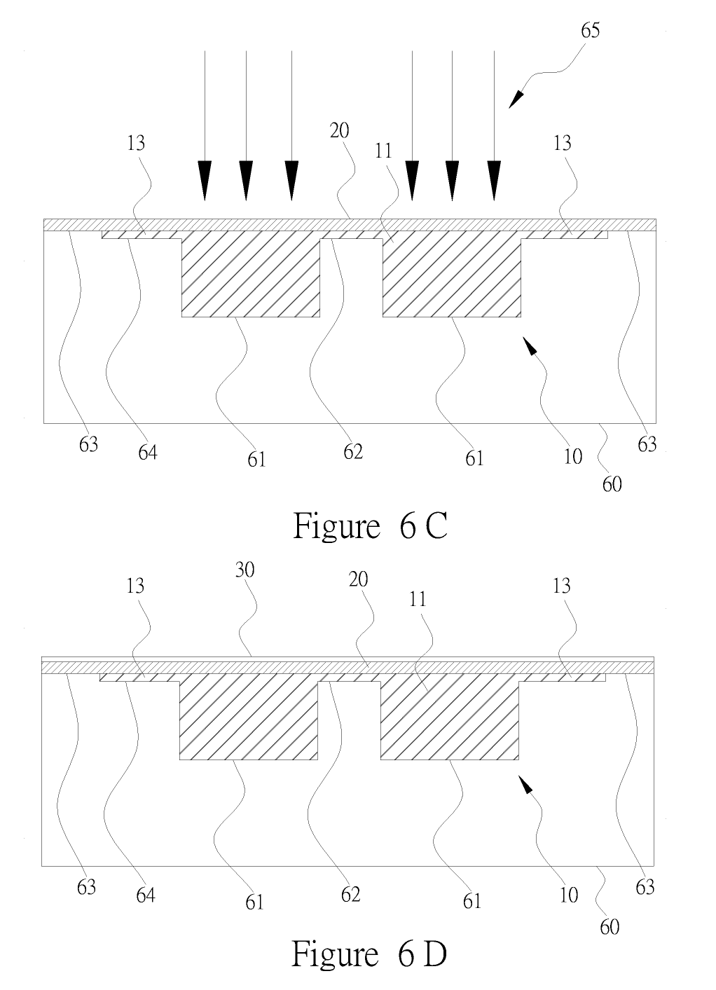

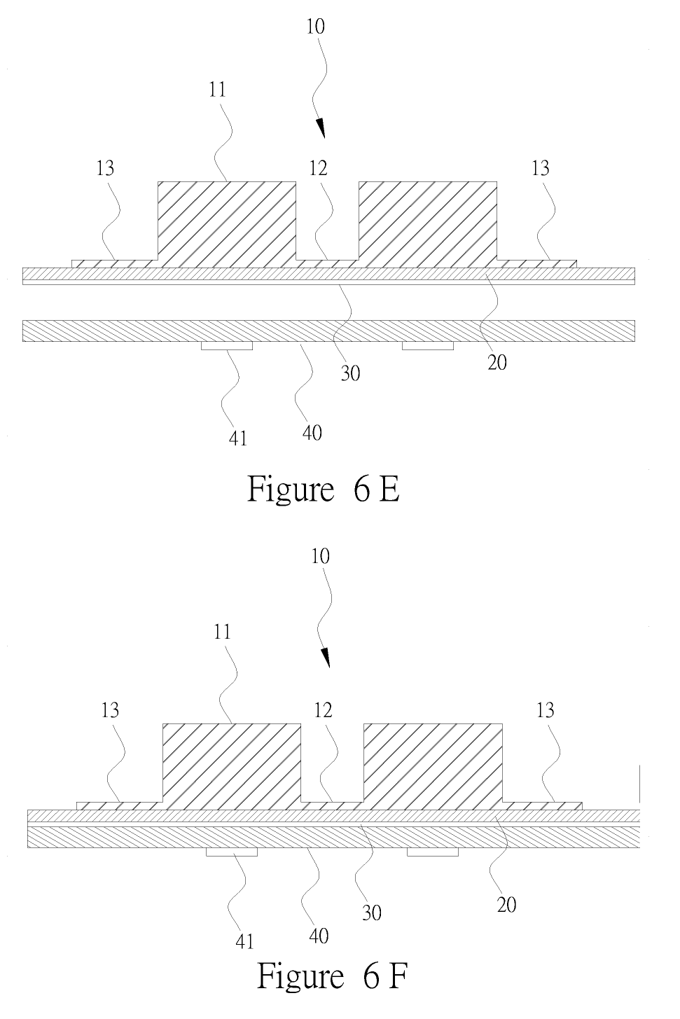

Refer from FIG. 5, FIG. 6A to FIG. 6F, a flow char of a first embodiment of a keypad manufacturing method according to the present invention includes the steps of:

(1) pouring materials for a keypad into a mold (step 51). The material such as resin is poured into a mold 60, as shown in FIG. 6A so as to form the keypad set 10. The mold 60 is disposed with a plurality of forming slots 61. A thin connecting slot 62 is arranged between the two adjacent forming slots 61 while the height of the bottom of the thin connecting slot 62 is lower than that of a mold side 63. One side of the forming slot 61 that is the most close to the lateral side of the mold 60 extends to form a thin lateral slot 64 whose height of the bottom is also lower than the one mold side 63. Thus by the connecting slot 62 and the lateral slot 64, the connecting piece 12 and the side piece 13 are formed. (2) covering a film on the mold (step 52). That means the film 20 is covered on the mold 60 and attached on the mold side 63, as shown in FIG. 6B. (3) curing (step 53). Refer to FIG. 6C, the keypad set 10 is cured and connected with the film 20 firmly by UV radiation. (4) film printing (step 54). Pint the semi-product for arranging a printed layer 30 on the film so that preset characters or symbols are formed on the film 20 corresponding to the keypads, as shown in FIG. 6D. (5) die-cutting and surface treatment (step 55); printed semi-product is released from the mold 60 for die-cutting and surface treatment; (6) attaching a layer of positioning plate (step 56); that's to attach the keypad set 10 with the film 20 as well as the printed layer 30 on the layer of positioning plate 40, as shown in FIG. 6E, FIG. 6F. Thus the keypad device 1 of the present invention is produced.

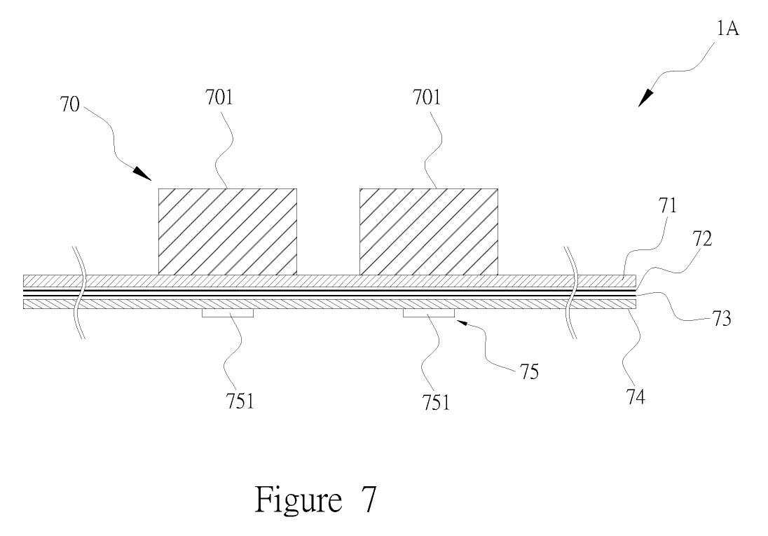

Refer to FIG. 7, a second embodiment of the keypad device 1A according to the present invention includes a keypad set 70, a first film 71, a printed layer 72, a glue layer 73, a second film 74 and an elastic member set 75. The keypad set 70 consists of a plurality of separated keypads 701 that is formed by transparent resin (or rubber) integratedly. There are two kinds of material of the keypad set 70-soft material or hard material. The hardness of the soft material is about pencil hardness HB (features on excellent scratch resistance) while the hardness of the hard material is about pencil hardness 2H. The first film 71 is a transparent layer (or a see-through layer) for loading and connecting the keypad set 70. That means the plurality of keypads 701 are cured and disposed on the top surface of the first film 71. The printed layer 72 is disposed on bottom side of the first film 71 and is able to be disposed on the first film 71 by a printing way so as to form characters and symbols corresponding to the keypads 701. The glue layer 73 is disposed under the first film 71 and the printed layer 72 and is used to connect the first film 71 and the second film 74. Or the glue layer 73 can be arranged over the second film 74 for connecting the first film 71 and the second film 74. That means the glue layer 73 is disposed between the first film 71 and the second film 74. The second film 74 is made from rubber or Electro Luminescent/light guiding material such as Rubber,EL,LGP,LGF,LGR etc. The elastic member set 75 is formed by a plurality of elastic members that are arranged under the second film 74, corresponding to the keypads 701.

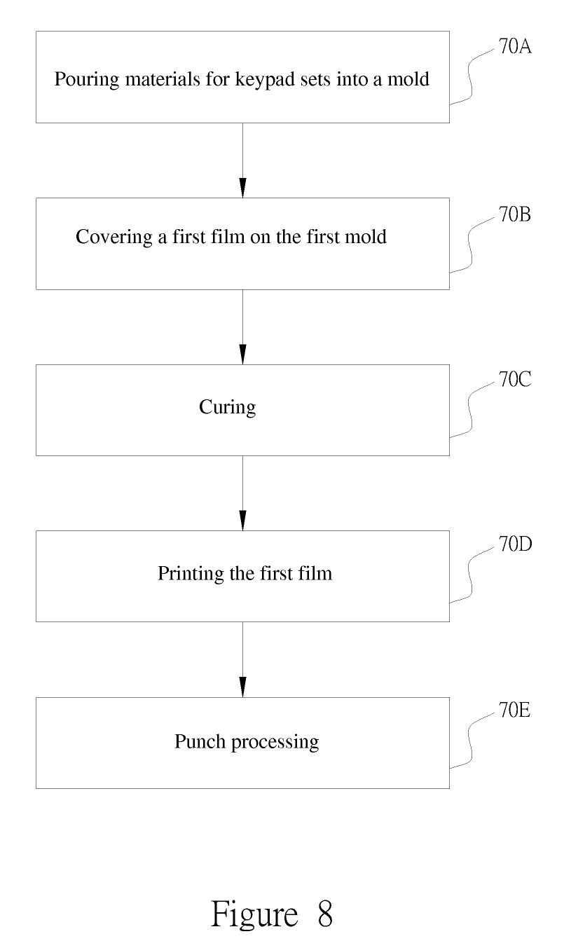

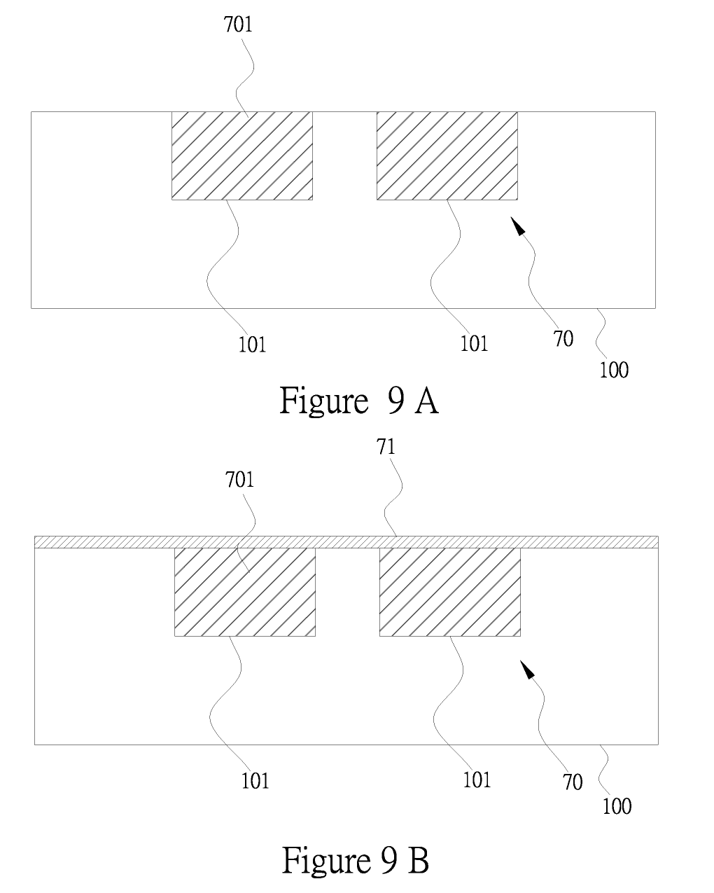

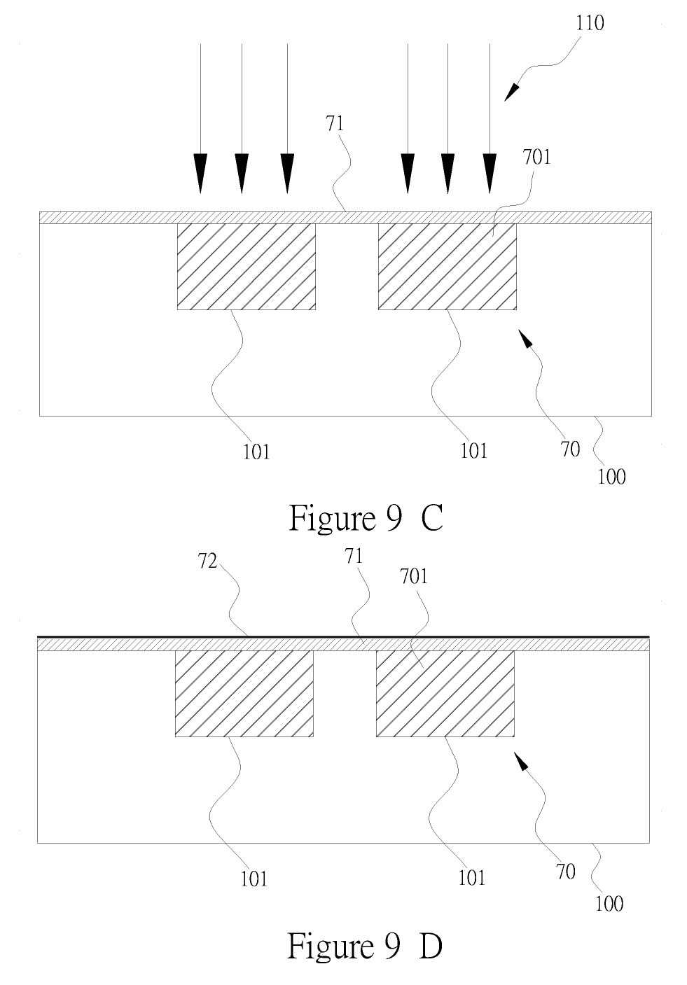

Refer from FIG. 8 to FIG. 12, a flow char of a second embodiment of a keypad manufacturing method according to the present invention is revealed. As shown in FIG. 8 & FIG. 9D, the molding of the keypad set 70 includes the steps of:

(1) 70A Pouring materials for keypad sets into a mold; as shown in FIG. 9A, pour resin (or rubber) into a first mold 100 that is disposed with a plurality of molding slots 101 for producing the keypad set 70. (2) 70B Covering a first film on the first mold. As shown in FIG. 9B, cover the first film 71 over the first mold 100. (3) 70C Curing: applying UV light 110, as shown in FIG. 9C, to cure the keypad sets 70 and connect the keypad sets 70 firmly with the first film 71. (4) 70D Printing the first film. The cured semi-product is printed to form the printed layer 72 with characters and symbols corresponding to the keypads 701. (5) 70E Punch processing: the printed semi-product is released from the first mold 100 and is punched for shape processing. Thus a semi-product of the keypad set 70 is obtained.

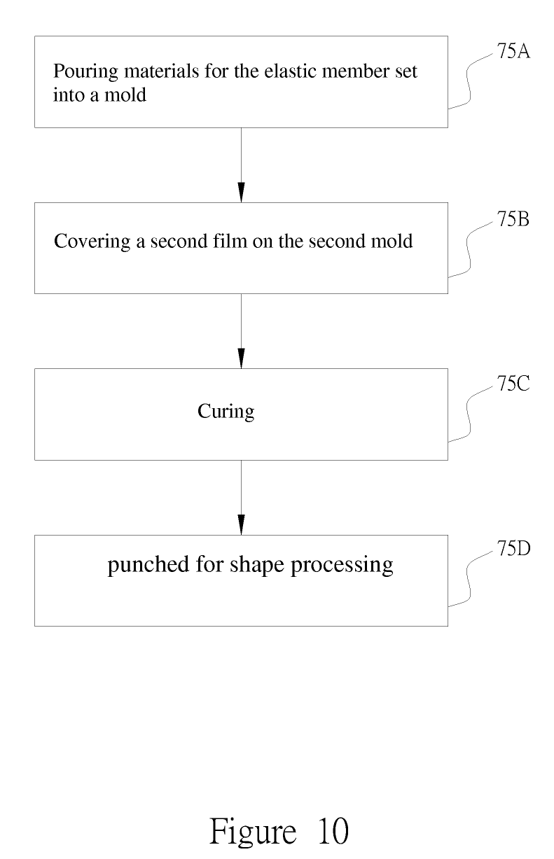

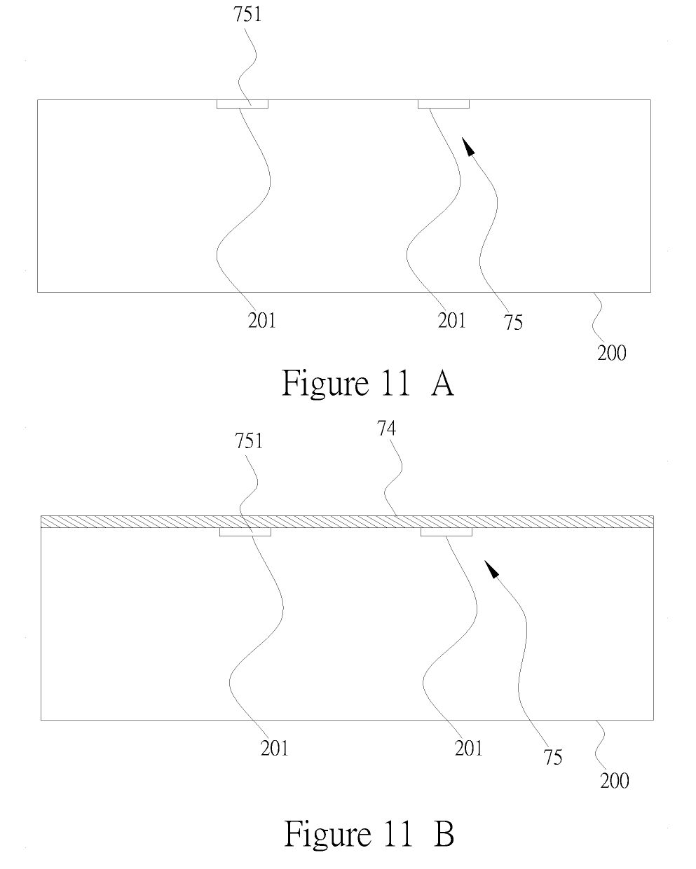

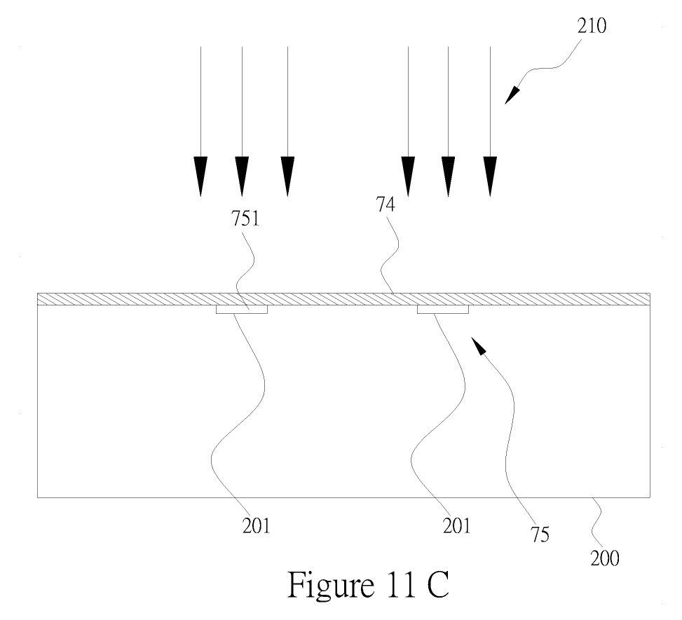

Refer from FIG. 10 to FIG. 11, the molding of the elastic member set 75 includes the steps of: (1) 75A Pouring materials for the elastic member set into a mold; as shown in FIG. 11A, pour resin (or rubber) into a second mold 200 that is disposed with a plurality of molding slots 201 for producing the elastic member set 75. (2) 75B Covering a second film on the second mold. As shown in FIG. 11B, cover the second film 74 over the second mold 200. (3) 75C Curing: applying UV light 210, as shown in FIG. 11C, to cure the elastic member set 75 and connect the elastic member set 75 firmly with the second film 74. (4) 75D Punch processing: the printed semi-product is released from the second mold 200 and is punched for shape processing. Thus the manufacturing processes of the elastic member set 75 are finished.

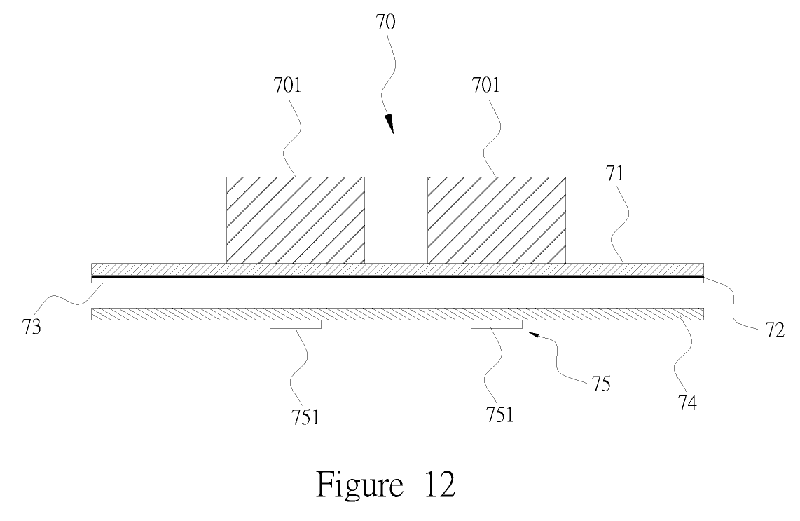

As shown in FIG. 12, the semi-product of the keypad set 70 and the semi-product of the elastic member set 75 are connected with each other by the glue layer 73. That means the first film 71 is glued with the second film 74. Thus the keypad device 1A of the present invention is produced.

Both the semi-product of the keypad set and the semi-product of the elastic member set are produced by non injection technique and the are glued to form the keypad device. Thus under shorter processes, the quality control and yield rate are effectively controlled and dramatically improved. The defects that increase the cost and reduce economic effects will not be found after all manufacturing steps. Moreover, the semi-product of the keypad set and the semi-product of the elastic member set are produced respectively and there is only a first film and a second film on the semi-products. Thus it's easier to remove bubbles in the resin or the rubber so as to get the keypad set and the elastic member set with higher quality. Furthermore, the keypad set and the elastic member set are cured by UV light integratedly. The production speed is fast and the UV curing is even. Thus the economic effects, product quality and product competitiveness are improved. In summary, the device and the method of the present invention can produce parts economically and fast, further reduce cost and have economic effects.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A keypad manufacturing method comprising the steps of:
(1) pouring materials for a keypad into a mold;
(2) covering a film on the mold;
(3) film printing: arranging a printed layer on the film;
(4) attaching a layer of positioning plate; attaching the film with the printed layer on the layer of positioning plate.

2. The method as claimed in claim 1, wherein in the step of pouring materials for a keypad into a mold, the material is resin.

3. The method as claimed in claim 1, wherein in the step of covering a film on the mold, the mold is disposed with a plurality of forming slots and a thin connecting slots is arranged between two adjacent forming slots while a thin lateral slot extends from one side of the forming slot that is the most close to the lateral side of the mold.

4. The method as claimed in claim 3, wherein the height of the bottom of the thin connecting slot is lower than the height of a mold side while the height of the bottom of the lateral slot is lower than the height of the mold side.

5. The method as claimed in claim 4, wherein in the step of covering a film on the mold, the film is covered and attached on a mold side of the mold.

6. The method as claimed in claim 1, wherein a curing is run before the step of arranging a printed layer on the film and the curing is to apply UV light.

7. The method as claimed in claim 1, wherein before the step of attaching a layer of positioning plate, the method further comprising a step of punching for shape processing.

8. A keypad manufacturing method comprising the steps of:
(1) pouring materials for keypad sets into a first mold;
(2) covering a first film on the first mold;
(3) curing: applying UV light to cure the keypad sets and connect the keypad sets firmly with the first film;
(4) printing the first film to get a semi-product of the keypad set;
(5) assembling the semi-product of the keypad set with a semi-product of an elastic member set which is formed by pouring materials for the elastic member set into a second mold and then covering a second film on the second mold to be irradiated by UV light for curing the elastic member set and connecting the elastic member set tightly with the second film.

9. The method as claimed in claim 8, wherein after the step of printing the first film to get a semi-product of the keypad set, there is a glue layer over the first film.

10. The method as claimed in claim 8, wherein in the step of assembling the semi-product of the keypad set with a semi-product of an elastic member set, a glue layer for connection is disposed between the first film and the second film.

11. The method as claimed in claim 8, wherein in the step of pouring materials for keypad sets into a first mold, the materials for keypad sets include resin or rubber.

12. The method as claimed in claim 8, wherein in the step of assembling the semi-product of the keypad set with a semi-product of an elastic member set, the materials for the elastic member set include rubber or resin.

13. A keypad device comprising:
a keypad set having a plurality of keypads;
a first film for loading the keypad set while the keypad set is connected with the first film by UV irradiation;
a printed layer arranged on bottom of the first film;
a second film;
an elastic member set arranged under the second film and having a plurality of elastic members that are connected with the second film by UV irradiation; and
a glue layer disposed between the first film and the second film for connecting the first film with the second film firmly.

14. The device as claimed in claim 13, wherein the printed layer includes characters, symbols, or figures.

15. The device as claimed in claim 13, wherein the elastic member is corresponding to the keypad.
